(19) United States
(12) Patent Application Publication
(10) Pub. No.: US 2026/0106058 A1
(43) Pub. Date: Apr. 16, 2026

(54) Resistor Carrier, Resistor Lead Bending System And Resistor Lead Bending Method

(71) Applicants: TE Connectivity Solutions GmbH, Schaffhausen (CH); Tyco Electronics (Shanghai) Co., Ltd., Shanghai (CN)

(72) Inventors: Yang Li, Shanghai (CN); Fengchun (Fred) Xie, Shanghai (CN); Lvhai (Samuel) Hu, Shanghai (CN); Sun Kyu Pak, Middletown, PA (US); Kyle Lunsford, Winston Salem, NC (US)

(73) Assignees: TE Connectivity Solutions GmbH, Schaffhausen (CH); Tyco Electronics (Shanghai) Co., Ltd., Shanghai (CN)

(21) Appl. No.: 19/285,343

(22) Filed: Jul. 30, 2025

(30) Foreign Application Priority Data
Jul. 30, 2024 (CN) 202411037421.1

(51) Int. Cl. H01C 17/28; H01C 1/01; H01C 1/14

(52) U.S. Cl. CPC H01C 17/28; H01C 1/01; H01C 1/14

(57) ABSTRACT

A resistor carrier includes a support body and a holding structure. The support body has a bar shape and two opposite sides in a width direction of the support body. The holding structure is on a top surface of the support body. The holding structure holds a resistor body of a resistor. When the resistor body of the resistor is held in the holding structure, a pair of leads of the resistor are suspended above the top surface of the support body. Each lead extends from one of the two sides of the support body such that the leads are each bendable relative to the resistor body.

### CROSS-REFERENCE TO RELATED APPLICATION

This application claims the benefit of the filing date under 35 U.S.C. § 119(a)-(d) of Chinese Patent Application No. CN202411037421.1 filed on Jul. 30, 2024, the whole disclosure of which is incorporated herein by reference.

### FIELD OF THE INVENTION

The present invention relates to a resistor carrier and, more particularly, to a resistor carrier, a resistor lead bending system including the resistor carrier, and a method for bending the resistor carrier using the resistor lead bending system.

### BACKGROUND OF THE INVENTION

In the prior art, resistor leads of resistance products usually need to be bent into a predetermined shape. In the prior art, manual bending of the resistor leads is required as there is no device for automatic bending of resistor leads. Typically, the resistor leads are required to be inserted into a special mold by a worker and are then forcefully bent. Manual bending of the resistor leads, however, has a low efficiency and a high cost, and cannot be integrated into an automated production line, thereby reducing the production efficiency of electronic products.

### SUMMARY OF THE INVENTION

A resistor carrier includes a support body and a holding structure. The support body has a bar shape and two opposite sides in a width direction of the support body. The holding structure is on a top surface of the support body. The holding structure holds a resistor body of a resistor. When the resistor body of the resistor is held in the holding structure, a pair of leads of the resistor are suspended above the top surface of the support body. Each lead extends from one of the two sides of the support body such that the leads are each bendable relative to the resistor body.

### BRIEF DESCRIPTION OF DRAWINGS

The invention will now be described by way of example with reference to the accompanying figures, of which:

FIG. 1 is a perspective view of a resistor carrier according to an exemplary embodiment, where leads of resistors held on the resistor carrier have not yet been bent;

FIG. 2 is a partial enlarged view of the resistor carrier of FIG. 1, where leads of the resistor of FIG. 1 held on the resistor carrier have not yet been bent;

FIG. 3 is a partial enlarged view of the resistor carrier of FIG. 1, where the leads of FIG. 2 of the resistor of FIG. 1 held on the resistor carrier have been bent;

FIG. 4 is a plan view of one resistor of FIG. 1, where leads of the resistor have not yet been bent;

FIG. 5 is a plan view of a resistance product according to an exemplary embodiment, where a pair of terminals are respectively crimped to a pair of leads of one resistor of FIG. 1;

FIG. 6 is a plan view of the resistance product of FIG. 5, where the pair of leads of FIG. 5 of one resistor of FIG. 1 are bent to a first bent shape;

FIG. 7 is a plan view of the resistance product of FIG. 5, where the pair of leads of FIG. 5 of one resistor of FIG. 1 are bent from the first bent shape of FIG. 6 to a second bent shape;

FIG. 8 is a plan view of a third bending device according to an exemplary embodiment and the resistor carrier of FIG. 1, where the pair of leads of FIG. 5 of one resistor of FIG. 1 are bent together by the third bending device and the resistor carrier to a third bent shape;

FIG. 9 is a plan view of the resistance product of FIG. 5, where the pair of leads of FIG. 5 of one resistor of FIG. 1 are bent from the second bent shape of FIG. 7 to a third bent shape; and

FIG. 10 is a plan view of a resistor lead bending system according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

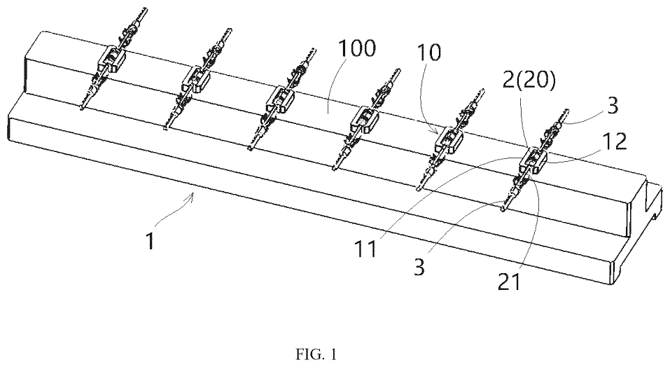

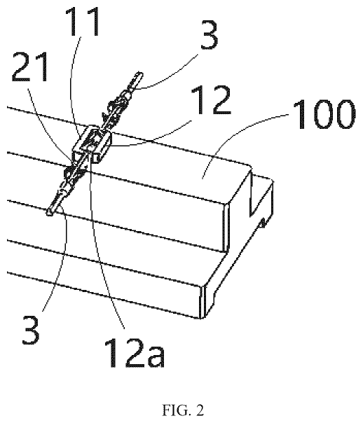

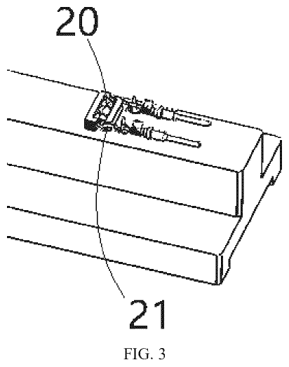

An exemplary embodiment of a resistor carrier 1 will now be described with reference to FIGS. 1-3, 8, and 10. As shown in FIGS. 1-2, the resistor carrier 1 includes a support body 100 and a holding structure 10. The support body 100 is in the shape of a bar and has two opposite sides in a width direction thereof. The holding structure 10, as shown in FIG. 1, is located on a top surface of the support body 100 for holding a resistor body 20 of a resistor 2. As shown in FIGS. 1-2, when the resistor body 20 of the resistor 2 is held in the holding structure 10, a pair of leads 21 of the resistor 2 are suspended above the top surface of the support body 100 and extend respectively from the two sides of the support body 100, to allow the leads 21 of the resistor 2 to be bent relative to the resistor body 20.

As shown in FIGS. 1-2, the holding structure 10 includes a front holding body 11 and a rear holding body 12 opposite each other in a length direction of the support body 100. The resistor body 20 is adapted to be held between the front holding body 11 and the rear holding body 12.

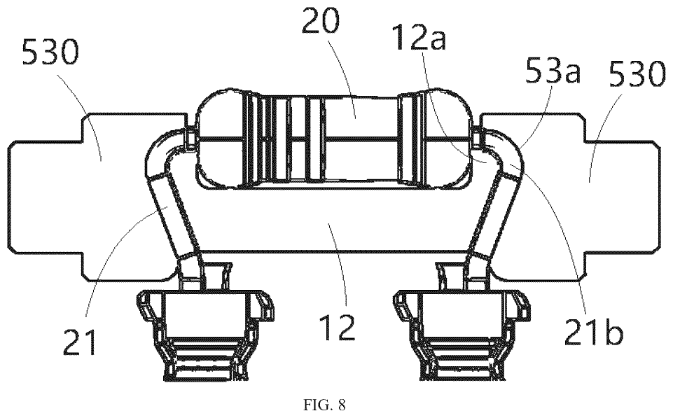

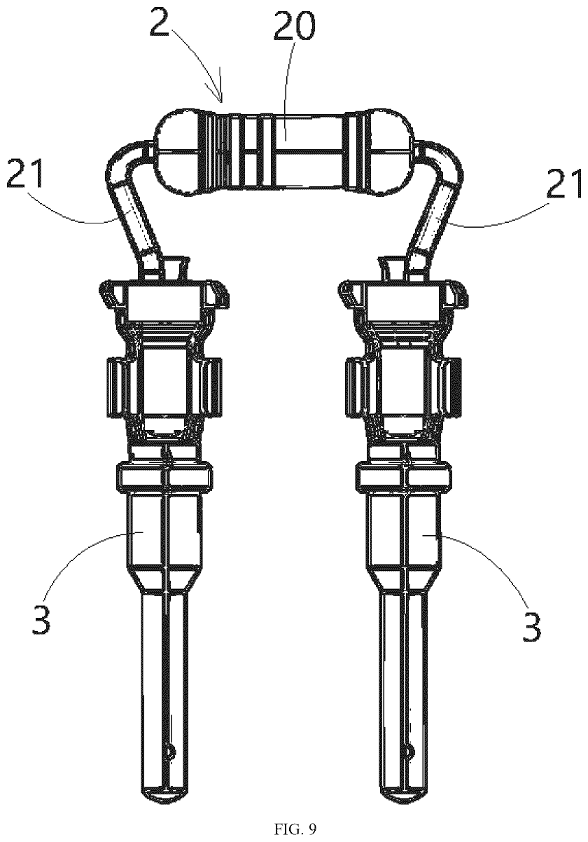

The rear holding body 12 has a pair of shaped portions 12a, as shown in FIGS. 2 and 8, opposite each other in the width direction of the support body 100. Outer sides of the pair of shaped portions 12a of the rear holding body 12 are respectively shaped into a predetermined shape and are configured to respectively abut against the pair of leads 21 after bending, to ensure that the pair of leads 21 are bent into a predetermined shape. A front positioning groove for receiving and positioning a portion of the resistor body 20 is formed in the front holding body 11. A rear positioning groove for receiving and positioning the other portion of the resistor body 20 is formed in the rear holding body 12.

As shown in FIG. 1, a plurality of holding structures 10 are provided on the support body 100. The plurality of holding structures 10 are spaced apart in a length direction of the support body 100 for holding a plurality of resistors 2, respectively.

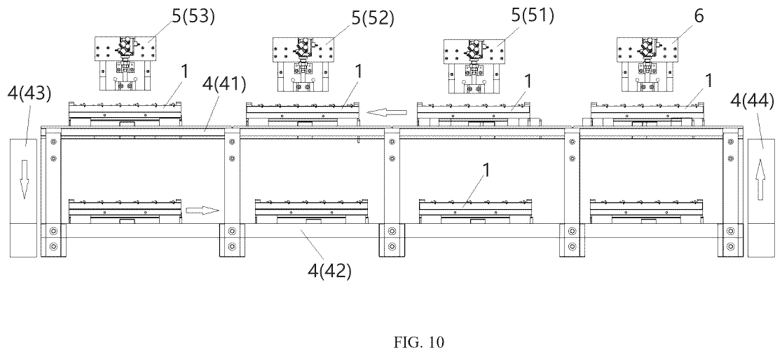

An exemplary embodiment of a resistor lead bending system will now be described with reference to FIGS. 1-3, 8, and 10. As shown in FIG. 10, the resistor lead bending system includes a resistor carrier 1, a conveying device 4, and a bending device 5. The conveying device 4 is configured to convey the resistor carrier 1 and a resistor 2 held on the resistor carrier 1 to a bending station. The bending device 5 is disposed at the bending station and is configured to bend a lead 21 of the resistor 2 that is conveyed to the bending station. The resistor lead bending system, as shown in FIG. 10, has a plurality of bending stations arranged sequentially and spaced apart in a conveying direction of the resistor carrier 1. The resistor lead bending system also includes a plurality of bending devices 5 respectively arranged at the plurality of bending stations for gradually bending the lead 21 of the resistor 2.

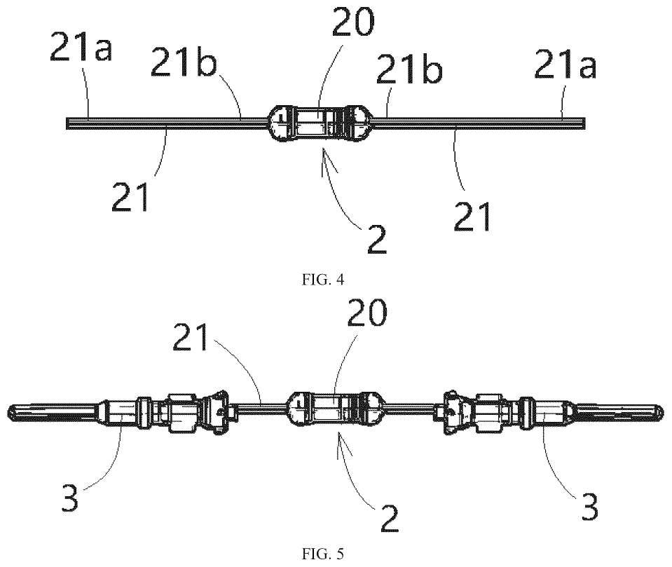

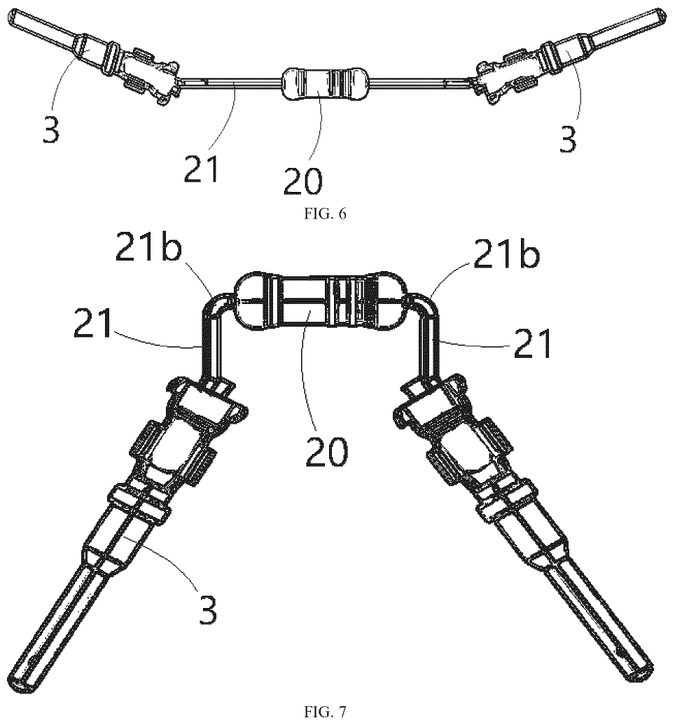

As shown in FIG. 10, the bending station includes a first bending station, and the bending device 5 includes a first bending device 51 disposed at the first bending station. The first bending device 51 is configured to bend the lead 21 of the resistor 2 to a first bent shape. As shown in FIG. 4, the lead 21 of the resistor 2 has a connection end 21a for electrical connection with a terminal 3. The first bending device 51 is configured to bend the connection end 21a of the lead 21, so that the connection end 21a of the lead 21 is bent at a first angle, as shown in FIG. 6, relative to the resistor body 20.

As shown in FIG. 10, the bending station further includes a second bending station arranged downstream of the first bending station, and the bending device 5 further includes a second bending device 52 disposed at the second bending station. The second bending device 52 is configured to bend the lead 21 of the resistor 2 from the first bent shape to a second bent shape. As shown in FIGS. 5 and 7, the lead 21 of the resistor 2 has a root 21b adjacent to the resistor body 20. The second bending device 52 is configured to bend the root 21b of the lead 21, so that the root 21b of the lead 21 is bent at a second angle, as shown in FIG. 7, relative to the resistor body 20.

As shown in FIG. 10, the bending station further includes a third bending station arranged downstream of the second bending station, and the bending device 5 further includes a third bending device 53 disposed at the third bending station. The third bending device 53 is configured to bend the lead 21 of the resistor 2 from the second bent shape to a third bent shape. The third bending device 53 is configured to further bend the root 21b of the lead 21, so that the root 21b of the lead 21 is bent from the second angle to a third angle, as shown in FIGS. 8-9, relative to the resistor body 20.

As shown in FIG. 6, the first angle is greater than zero degrees and less than 60 degrees. As shown in FIG. 7, the second angle is equal to 90 degrees. As shown in FIGS. 8-9, the third angle is greater than 90 degrees and less than 150 degrees.

As shown in FIG. 8, the third bending device 53 includes a pair of ejector blocks 530 formed with shaped grooves 53a. The lead 21 of the resistor 2 is adapted to be pressed between an inner side of the shaped groove 53a of the ejector block 530 and an outer side of a shaped portion 12a of a rear holding body 12 of the resistor carrier 1 to bend the lead 21 into the third bent shape.

As shown in FIG. 10, the resistor lead bending system further includes a loading device 6 disposed at a loading station located upstream of the bending station. The loading device 6 is configured to load the resistor 2 onto the resistor carrier 1.

As shown in FIG. 10, the conveying device 4 includes an upper conveying device 41 and a lower conveying device 42. The upper conveying device 41 is configured to convey the resistor carrier 1 loaded with the resistor 2 from an initial loading station to the bending station. The lower conveying device 42 is arranged below the upper conveying device 41 and is configured to convey the empty resistor carrier 1, with the resistor 2 thereon unloaded, to the initial loading station. As shown in FIG. 10, the conveying device 4 further includes a front lifting device 43 and a rear lifting device 44. The front lifting device 43 is disposed between front ends of the upper conveying device 41 and the lower conveying device 42 for conveys the resistor carrier 1 from the upper conveying device 41 downwardly to the lower conveying device 42. The rear lifting device 44 is disposed between rear ends of the upper conveying device 41 and the lower conveying device 42 for conveying the resistor carrier 1 from the lower conveying device 42 upwardly to the upper conveying device 41.

In the aforementioned various exemplary embodiments according to the present invention, the resistor lead bending system enables automatic bending of leads 21 of resistors 2, improves the bending efficiency of the leads 21 of the resistors 2, and can realize automated assembly line production of electronic products, thereby greatly improving the production efficiency of the electronic products.

An exemplary embodiment of a resistor lead bending method will now be described. The resistor lead bending method includes a step S10, a step S20, and a step S30. The step S10 includes: providing the above resistor lead bending system. The step S20 includes: holding the resistor body 20 of the resistor 2, as shown in FIGS. 1 and 3-9, of the resistance product onto the resistor carrier 1 at the loading station of the resistor lead bending system. As shown in FIGS. 1-2, 5-7, and 9, the resistance product includes the resistor 2 and a pair of terminals 3 respectively crimped to connection ends 21a of a pair of leads 21 of the resistor 2. The step S30 includes: conveying the resistor carrier 1 and the resistance product held thereon from the loading station to the first bending station and bending the lead 21 of the resistor 2 to the first bent shape by using the first bending device 51 disposed at the first bending station. In the step S30, the first bending device 51 enables the connection end 21a of the lead 21 of the resistor 2 by pushing the terminal 3 to be bent at the first angle relative to the resistor body 20.

The resistor lead bending method also includes a step S40, and a step S50. The step S40 includes: conveying the resistor carrier 1 and the resistance product held thereon from the first bending station to the second bending station and bending the lead 21 of the resistor 2 from the first bent shape to the second bent shape by using the second bending device 52 disposed at the second bending station. The step S50 includes: conveying the resistor carrier 1 and the resistance product held thereon from the second bending station to the third bending station and bending the lead 21 of the resistor 2 from the second bent shape to the third bent shape by using the third bending device 53 disposed at the third bending station.

The above resistor lead bending method further includes a step S60 which includes: removing the bent resistance product from the resistor carrier 1; and a step S70 which includes: conveying the empty resistor carrier 1, with the resistance product thereon unloaded, to the initial loading station.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” an element or a plurality of elements having a particular property may include additional such elements not having that property.

1. A resistor carrier, comprising:
a support body having a bar shape and two opposite sides in a width direction of the support body; and
a holding structure on a top surface of the support body, the holding structure holds a resistor body of a resistor, when the resistor body of the resistor is held in the holding structure, a pair of leads of the resistor are suspended above the top surface of the support body, each lead extends from one of the two sides of the support body such that the leads are each bendable relative to the resistor body.

2. The resistor carrier of claim 1, wherein the holding structure has a front holding body and a rear holding body opposite each other in a length direction of the support body, the resistor body is held between the front holding body and the rear holding body.

3. The resistor carrier of claim 2, wherein the rear holding body has a pair of shaped portions opposite each other in the width direction of the support body, outer sides of the pair of shaped portions are shaped into a predetermined shape and abut against the pair of leads after bending to ensure that the pair of leads are each bent into a predetermined shape.

4. The resistor carrier of claim 3, wherein a front positioning groove receiving and positioning a portion of the resistor body is formed in the front holding body, and/or a rear positioning groove receiving and positioning an other portion of the resistor body is formed in the rear holding body.

5. A resistor lead bending system, comprising:
a resistor carrier including a support body and a holding structure, the support body has a bar shape and two opposite sides in a width direction of the support body, the holding structure is on a top surface of the support body;
a conveying device conveying the resistor carrier and a resistor held on the resistor carrier to a bending station, the holding structure holds a resistor body of the resistor, when the resistor body of the resistor is held in the holding structure, a pair of leads of the resistor are suspended above the top surface of the support body, each lead extends from one of the two sides of the support body such that the leads are each bendable relative to the resistor body; and
a bending device disposed at the bending station and bending each lead of the resistor that is conveyed to the bending station.

6. The resistor lead bending system of claim 5, wherein the resistor lead bending system has a plurality of bending stations arranged sequentially and spaced apart in a conveying direction of the resistor carrier, and a plurality of bending devices each arranged at one bending station, each bending device gradually bends each lead of the resistor.

7. The resistor lead bending system of claim 6, wherein the plurality of bending stations include a first bending station, and the plurality of bending devices include a first bending device disposed at the first bending station, the first bending device bends each lead to a first bent shape.

8. The resistor lead bending system of claim 7, wherein each lead of the resistor has a connection end for electrical connection with a terminal, the first bending device bends each connection end such that each connection end is bent at a first angle relative to the resistor body.

9. The resistor lead bending system of claim 8, wherein the plurality of bending stations further includes a second bending station arranged downstream of the first bending station, and the plurality of bending devices further includes a second bending device disposed at the second bending station, the second bending device bends each lead from the first bent shape to a second bent shape.

10. The resistor lead bending system of claim 9, wherein each lead has a root adjacent to the resistor body, the second bending device bends each root such that each root is bent at a second angle relative to the resistor body.

11. The resistor lead bending system of claim 10, wherein the plurality of bending stations further includes a third bending station arranged downstream of the second bending station, and the plurality of bending devices further includes a third bending device disposed at the third bending station, the third bending device bends each lead from the second bent shape to a third bent shape.

12. The resistor lead bending system of claim 11, wherein the third bending device further bends each root such that each root is bent from the second angle to a third angle relative to the resistor body.

13. The resistor lead bending system of claim 12, wherein the first angle is greater than zero degrees and less than 60 degrees, the second angle is equal to 90 degrees, and the third angle is greater than 90 degrees and less than 150 degrees.

14. The resistor lead bending system of claim 11, wherein the third bending device has a pair of ejector blocks formed with shaped grooves, each lead is pressed between an inner side of the shaped groove of one ejector block and an outer side of a shaped portion of a rear holding body of the resistor carrier to bend each lead into the third bent shape.

15. The resistor lead bending system of claim 5, further comprising a loading device disposed at a loading station upstream of the bending station, the loading device loads the resistor onto the resistor carrier.

16. The resistor lead bending system of claim 5, wherein the conveying device includes an upper conveying device and a lower conveying device, the upper conveying device conveys the resistor carrier loaded with the resistor from an initial loading station to the bending station, the lower conveying device is arranged below the upper conveying device and conveys the resistor carrier, with the resistor thereon unloaded, to the initial loading station.

17. The resistor lead bending system of claim 16, wherein the conveying device further includes a front lifting device and a rear lifting device, the front lifting device is disposed between front ends of the upper conveying device and the lower conveying device, the front lifting device conveys the resistor carrier from the upper conveying device downwardly to the lower conveying device, the rear lifting device is disposed between rear ends of the upper conveying device and the lower conveying device, the rear lifting device conveys the resistor carrier from the lower conveying device upwardly to the upper conveying device.

18. A resistor lead bending method, comprising:
providing a resistor lead bending system including a resistor carrier, a conveying device, and a plurality of bending devices, the resistor carrier includes a support body and a holding structure, the support body has a bar shape and two opposite sides in a width direction of the support body, the holding structure is on a top surface of the support body;
holding a resistor body of a resistor of a resistance product onto the resistor carrier at a loading station of the resistor lead bending system, the resistance product includes the resistor and a pair of terminals each crimped to one connection end of one lead of a pair of leads of the resistor, the holding structure holds the resistor body of the resistor, when the resistor body of the resistor is held in the holding structure, the pair of leads are suspended above the top surface of the support body, each lead extends from one of the two sides of the support body such that the leads are each bendable relative to the resistor body;
conveying, with the conveying device, the resistor carrier and the resistance product held thereon from the loading station to a first bending station, and bending each lead of the resistor to a first bent shape with a first bending device of the plurality of bending devices disposed at the first bending station;
conveying, with the conveying device, the resistor carrier and the resistance product held thereon from the first bending station to a second bending station, and bending each lead of the resistor from the first bent shape to a second bent shape with a second bending device of the plurality of bending devices disposed at the second bending station; and
conveying, with the conveying device, the resistor carrier and the resistance product held thereon from the second bending station to a third bending station, and bending each lead of the resistor from the second bent shape to a third bent shape with a third bending device of the plurality of bending devices disposed at the third bending station.

19. The resistor lead bending method of claim 18, further comprising removing the bent resistance product from the resistor carrier after each lead is bent to the third bent shape, and conveying, with the conveying device, the resistor carrier to an initial loading station after the resistance product having each lead bent to the third bent shape is removed from the resistor carrier.

20. The resistor lead bending method of claim 18, wherein, each lead of the resistor has a connection end for electrical connection with a terminal, and, in the conveying the resistor carrier and the resistance product held thereon from the loading station to the first bending station step, the first bending device enables a connection end of the lead of the resistor by pushing each terminal to be bent at a first angle relative to the resistor body.
